(19) United States
(12) Patent Application Publication
(10) Pub. No.: US 2021/0227748 A1
(43) Pub. Date: Jul. 29, 2021

(54) Side-Directed Rotary Cutter

(71) Applicants: Will Thompson, Decatur, TN (US); Baily Turner, Decatur, TN (US)

(72) Inventors: Will Thompson, Decatur, TN (US); Baily Turner, Decatur, TN (US)

(21) Appl. No.: 17/155,409

(22) Filed: Jan. 22, 2021

Related U.S. Application Data
(60) Provisional application No. 62/966,675, filed on Jan. 28, 2020.

(51) Int. Cl. A01D 34/86; A01D 34/64; A01D 34/74

(52) U.S. Cl. CPC A01D 34/866; A01D 2101/00; A01D 34/74; A01D 34/64

(57) ABSTRACT

A cutter for use with a mower such as a front of a tractor or skid steer has at least one cutting blade disposed below a cutting deck. A first arm assembly connects at a pivot to the deck and preferably connects to an extension extending forwardly relative to a mounting plate connected to the mower. The pivot is preferably spaced by a portion of the arm assembly from a length of the mounting plate. A roller assembly may be utilized to support the cutting blades above a surface to be cut. A second arm assembly may selectively position the cutting deck at preselected angles about the pivot. The first arm assembly may have curved ribs to allow the cutting deck to be declined to a negative angle relative to the pivot.

### CLAIM OF PRIORITY

This application claims the benefit of U.S. Provisional Application No. 62/966,675 filed Jan. 28, 2020 which is incorporated herein by reference in its entirety.

### FIELD OF THE INVENTION

The present invention relates to a side-directed rotary cutter and more particularly to a side directed rotary cutter connected at a front of a vehicle such as a tractor, skid-steer, Front End Loader, etc., for use in cutting to a side (as opposed to a front or rear of the vehicle).

### BACKGROUND OF THE INVENTION

Various efforts have been made to provide side mounted rotary cutters for use with front attach mowing vehicles. U.S. Pat. No. 10,470,364 is one example, if valid. Other similar designs have been around for many years.

U.S. Patent Application No. 2018/0338,421 is another side mounting rotary cutter which can be positioned between horizontal and vertical by the operator internal to the vehicle.

Nevertheless, these prior art designs are believed to create a situation whereby the operator must continually raise and lower the cutting deck so as not to gouge into uneven cutting areas. This requires a level of intensity that many tractor drivers do not enjoy as not only must the operator be diligently watching the path of travel of the vehicle but also the cutting deck.

Additionally, in a survey of the applicant's customers, very few reposition devices similar to the one in U.S. Pat. No. 10,470,304 to a configuration with the cutting head positioned in front of the tractor. Instead the cutting deck is apparently consistently left to the side of the vehicle.

However, many customers have complained of having to raise and lower the cutting deck to accommodate imperfections in the land to prevent gouging and/or uneven cutting. Other customers voiced other complaints.

Accordingly, the applicant believes improved side cutting rotary-cutters would be desirable for a front mounted applications.

### SUMMARY OF THE INVENTION

It is object of many embodiments of the present invention to provide an improved side-directed rotary cutter for use with front end mounted mowers such as tractors, skid-steers and other mowers.

It is another object of many embodiments of the present invention to provide a side directed mower having a floating configuration for at least some embodiments.

It is another object of many embodiments of the present invention to provide a side directed rotary cutter having a capability of providing a declined angle configuration relative to a horizontal at a first pivot located external to the mounting plate, if not external to wheels of a vehicle when installed, which may be particularly attractive in such applications as cutting downward slope on a dam or other applications.

It is another object of many embodiments of the present invention to provide an undercut capability for at least some embodiments relative to a pivot point located external to a mounting plate if not wheels of a vehicle.

It is another object of many embodiments of the present invention to provide a roller assembly having at least one roller for supporting the cutting deck and cutting blades above the roller to potentially prevent gouging.

Accordingly, in accordance with many embodiments of the present invention, an improved rotary cutter is provided. The rotary cutter preferably has one or more blades driven about a shaft below a cutting deck. The cutting deck preferably has a roller assembly connected thereto possibly with a scraper as a portion thereof so as to support the cutting deck above a surface, such as a ground surface, with one or more rollers contacting the ground. The cutting deck may move with the contour of the ground at the side of the vehicle in this configuration. The scraper(s) may keep the rollers relatively debris free.

Angular adjustment of the cutting deck can be fixed in some configurations. One may adjust an arm adjustment assembly to selectively position the deck at a pre-determined angle relative to the horizontal and/or mounting plate. However, even in such configuration(s), the roller assembly could still assist in preventing gouging, for at least some embodiments.

Additionally, by providing a curved arm assembly, angles of declination may be provided with the cutting deck extending into a radius of the curvature of the ribs of the arm assembly to potentially decline the cutting deck to orientations prior art designs lacked.

### BRIEF DESCRIPTION OF THE DRAWINGS

The particular features and advantages of the invention as well as other objects will become apparent from the following description taken in connection with the accompanying drawings in which:

FIG. 1 is a top perspective view of the presently preferred embodiment of the present invention;

FIG. 2 shows a rear perspective view of the embodiment shown in FIG. 1;

FIG. 3 is a bottom perspective view of the embodiments of FIGS. 1 and 2;

FIG. 4 is a front plan view of the embodiments show in FIGS. 1-3;

FIG. 5 is a front plan view similar to FIG. 4 with cutting deck angled to a descending angle;

FIG. 6 is a front plan view similar to FIGS. 4-5 showing the cutting deck of FIGS. 1-5 at an intermediate upward angle.

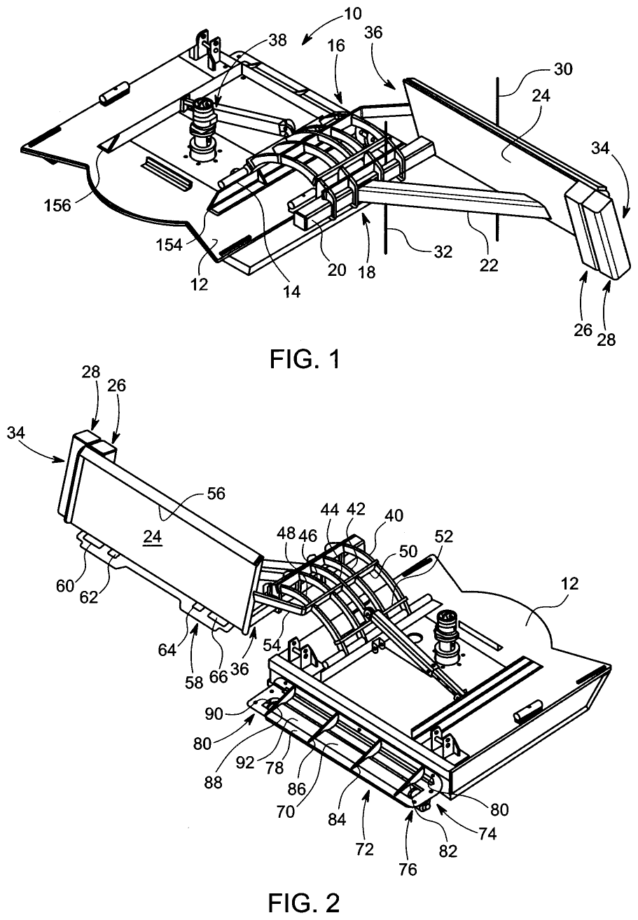

### DETAILED DESCRIPTION OF THE PREFERRED EMBODIMENT

In accordance with many embodiments of the present invention, the figures show a presently preferred embodiment of the present invention. A rotary cutter 10 has a cutting deck 12 which is preferably pivotably connected at a first pivot 14 through first arm assembly 16 to a shoulder 18 connected to a first extension 20.

Although first extension 20 is shown fixably connected to a plate such as a front end loader (FEL) mounted plate for use with front mount tractors and skid steer attachments, other embodiments may connect differently, possibly to other mowers. With this construction a cross-brace 22 may be helpful. Cross-brace 22 is shown extending opposite the center line 30 of the mounting plate 24 opposite the first extension 20 while also connecting to the first extension 20 at or forward of the center line 32 of the first extension 20. Other cross-braces 22 could connect differently, if utilized. One or more counterweights 26,28 can connect and/or be operably coupled to the mounting plate 24 opposite the center line 32 from the first extension 20 such as toward or at the end 34 so as to assist in balancing the load on the plate 24 as it connects to a vehicle such as a tractor, frontend loader, skid steer, etc. It is unknown if any prior art cutter has counter weights 26 or 28.

Unlike prior art designs where the cutting deck 12 is intended to be maintained in a fixed angular position relative to the mounting plate 24 such as by the use of pin locks or other locking systems, for at least some embodiments, the applicant provides a cutting deck that has a float configuration or movable relative to the surface on or into which it is desired to be cutting. More on this feature will be discussed below.

A hydraulic or other motor 38 is often connected to the hydraulic system of the vehicle as would be understood by those of ordinary skill in the art. Possibly a flow control valve might be desirable for many embodiments as well depending on the capacity of the particular vehicle at issue and sizing of the motor 38.

Arm assembly 16 is also believed to be different from prior art construction in that it can be comprised of a series of spaced-apart ribs 40,42,44,46 and 48 for at least some embodiments. There may be a possibility of more or fewer ribs 40-48 for other embodiments, possibly connected by one or more struts 50,52 in addition to the first pivot 14 and/or the shoulder 18 which will be described in more detail below. Ribs 40-48 may provide a way for the cutting deck 12 to flex if necessary relative to the first extension 20 such as if encountering an obstacle for at least some embodiments. Ribs 40-48 may also be curved to accommodate an angle of declination for at least some embodiments as described below.

Strut 50 may be spaced from first pivot 14 and shoulder 18 along the ribs 40-48 and be connected by foot 54 to the mounting plate 24. Mounting plate 24 may have a lip 56 and shelf 58 with a plurality of cutouts 60,62,64,66 which would permit the easy connection to various devices whether it be a skid steer, tractor, etc. Other mounting plates 24 may connect to vehicles with different structures.

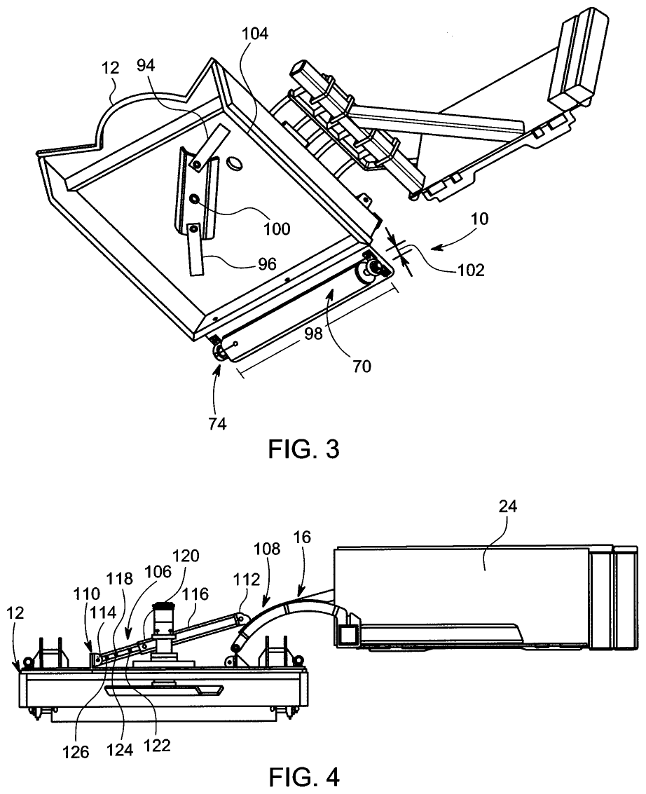

As shown in FIG. 2-6, the cutting deck 12 may have one or more rollers 70 possibly supported by a roller assembly 72 which may connect one or more rollers 70 to the cutting deck 12. The roller assembly 72 is shown at a rear 74 of the cutting deck 12 but could be located along other locations for other embodiments. The roller assembly 72 may include one or more pillow blocks bearings 76,77 or other bearings possibly connected to the roller assembly such as at a base 78 of the roller assembly which could be connected by flange 80 and possible supported by slats 82-88 for rigidity and/or strength for connecting at a rear 74 of the cutting deck 12 or other purposes. Also, the base 78 may have a cutout 90 at or about at an upper surface (or other surface) of the roller 72 whereby edges of the cutout 90, such as base 78, can act as a scraper so as to remove excess material from an exterior surface 92 of one or more rollers 70. In this embodiment, the edge of the base 78 can function as a scraper. In other embodiments, other scrapers may be provided so as to assist in removing debris from the exterior surface of the one or more rollers 70.

One or more rollers 70 can contact the ground to support the cutting blades 94,96 at a desired elevation of the surface to be cut to assist therein. One or more rollers 70 preferably extend up to or beyond a width 96 of the cutting path 104 created by the blades 94,96 as they rotate about shaft 100 driven by the motor 38. One or more rollers 70 preferably have a width 98 which are at least two times longer than a diameter 102 of the one or more rollers 70 if not roughly ten times as illustrated. At least one roller 70 is illustrated extending external to the cutting path 104 created by the blades 94,96 when rotating about the shaft 100.

For other still embodiments, the roller 70 and/or the roller assembly 72 is located at a rear 74 of the cutting deck 12 but could be located at other locations for various embodiments and possibly multiple roller assemblies 72 could be utilized possibly at various locations relative to cutting deck 12 for various embodiments as well. The cutting deck 12 may be fixed in position relative to the mounting plate 24 such as with adjustment arm assembly 106 which may have first and second mounts 108,110 which may be pivotably connected to the arm assembly 16 and/or the cutting deck 12 such as illustrated, with pivots 112,114 or otherwise. Even when fixed in position, roller assembly 72 may be useful to prevent gouging.

A first portion 116 of second arm assembly 106 is shown connected to a second portion 118 such as with pin 120 which could be located one of a plurality of openings such as 122,124,126 as illustrated or otherwise. Alternatively, the pin 120 may not be installed or otherwise arranged so that the cutting deck 12 can be in a float configuration supported by the roller assembly 72 so as to cut at a relative even elevation regardless of the contour of the surface for such the cutter 10 is directed.

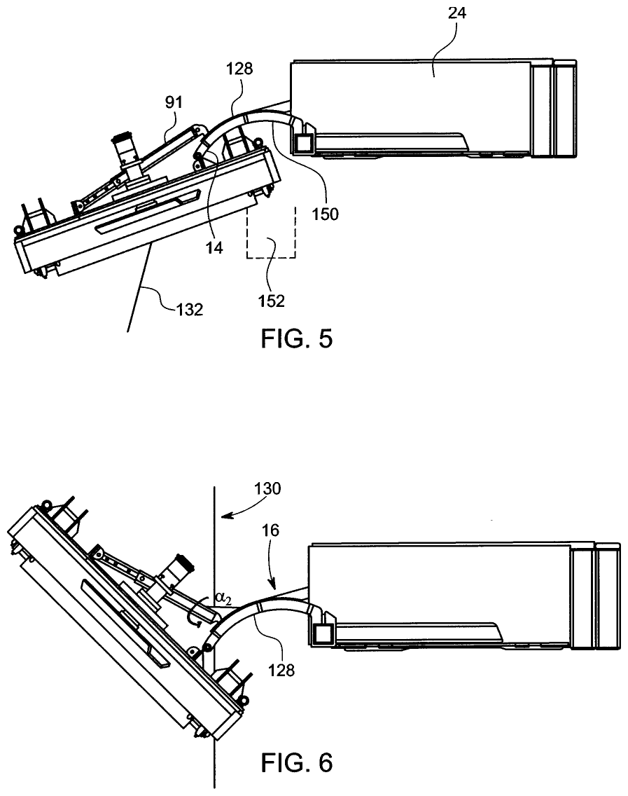

FIG. 4 shows the cutting deck 12 essentially horizontal such as to cut flat land. However, this design also can be declined such as shown in FIG. 5 and angled declination α₁ at about −15 degrees where it could be pinned or it could be allowed to float even farther such as up to past a declination angle of 45 degrees or possibly even more depending on the construction of the arm assembly 16 and the level of positioning of the first pivot 14 and/or other considerations. Curved ribs 40-48 can assist in providing clearance for the cutting deck 12 to decline relative to first pivot 14. This would be particularly helpful if one was driving along the top of a dam and cutting down along the edge the dam and/or for other purposes.

Similarly FIG. 6 has an angle of inclination α₂ relative to the horizontal 128 of up to 45 degrees as illustrated or even up to 90 as illustrated by line 130 in FIG. 6.

First there appears to be ability to “float” relative to the ground by contacting a ground surface with the roller 70 so as to prevent gouging and cutting at relatively even heights of the blades 94,96 relative to what is being cut. Additionally, counter weights 26,28 are useful so as to be able to balance the load of the mounting plate 24 relative to a tractor or other vehicle. Adjustment of the device is also believed to be easier than prior art constructions. Even preset positions can be provided in a somewhat desirable manner over prior art constructions by being able to fixably and rigidly secure positions with the adjustment arm assembly 106 relative to the first pivot 14 which is located outwardly of the end 36 of the mounting plate 24 for many embodiments such as against strengthening brace 156 and along arm assembly 16.

FIG. 5 shows the cutting deck 12 at an angle of declination α₁ relative to the horizontal 128. This is illustrated by a minus 15 degree angle in this view extend all the way up line 132 to a much greater angle of declination with the cutting deck 12 extending up into an arc of access 150 created by the ribs 40-48.

Wheel 152 is shown in phantom in FIG. 5 vehicle and the first pivot 14 is shown external to the mounting plate 24 as well as to the wheel 152 for at least some embodiments. This particular construction allows the vehicle to travel on top of a structure such as on top of a dam and cut on the side of it even at a steep angle to provide safety of the operator for at least some embodiments.

It will be remembered that the rotary cutter 10 is often connected to a front end of a vehicle such as a tractor, front end loader, skid steer, at mounting plate 24 can be raised or lowered by the operator to accommodate various situations.

First and second strengthening braces 154-156 to provide for many embodiments with the possibility of connecting the first pivot 14 to a top of the first strengthening brace 154 to the angle line or other construction. In this construction with the second strengthening 156 may receive the second pivot 110 of the adjustment or second arm assembly 106 for at least some embodiments to provide a convenient location for a connection thereto. In such construction, the adjustment or second arm assembly 106 can accommodate angular adjustment of the cutting deck 12 relative to the horizontal 128 external to the plate 24 and possibly the vehicle's tires 152 on that side.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A side directed rotary cutter comprising:
at least one blade rotatably driven below a cutting deck when connected to a mower;
a first arm assembly connecting the cutting deck at a pivot to the mower at a mounting plate whereby the pivot is located beyond a length of the mounting plate as spaced by the first arm assembly; and
one of (a) a roller assembly connected to the cutting deck, said roller assembly extending at least one roller below at least one blade; and
(b) a second arm assembly operably coupled to the cutting deck, said second arm assembly having a plurality of positions fixedly selecting one of a plurality of preselected angular orientations of the cutting deck relative to the pivot.

2. The cutter of claim 1 further comprising an extension extending forwardly relative to the mounting plate and the first arm assembly connects to the extension.

3. The cutter of claim 2 wherein the first arm assembly has a plurality of ribs extending parallel to one another intermediate the extension and the pivot.

4. The cutter of claim 3 wherein the ribs are curved with curvature about an axis parallel to the pivot permitting the cutting deck to angle about the pivot at a downward angle.

5. The cutter of claim 2 wherein the mounting plate connects to one of a front of a tractor and a skid steer.

6. The cutter of claim 2 wherein the extension is perpendicularly oriented relative to the mounting plate.

7. The cutter of claim 6 further comprising a cross brace extending from the mounting plate to the extension opposite from the arm assembly, said cross brace providing lateral support to the extension.

8. The cutter of claim 1 wherein the cutter has a float configuration whereby the roller is in constant contact with a ground surface supporting the at least one blade there above in operation with the pivot being unrestrained from pivoting about the pivot.

9. The cutter of claim 1 wherein the roller assembly is connected at a rear of the cutting deck.

10. The cuter of claim 9 wherein a roller of the at least one roller has a width at least twice as long as a diameter of the roller.

11. The cutter of claim 9 wherein the at least one roller extends beyond a cutting path of the at least one blade.

12. The cutter of claim 9 wherein the at least one roller has a width at least as wide as a width of the cutting path of the at least one blade.

13. The cutter of claim 1 further comprising a scraper retained securely relative to the cutting deck, said scraper removing material extending beyond a predetermined distance from an exterior surface of the at least one roller.

14. The cutter of claim 13 wherein the scraper is an edge of a base at a cutout receiving the roller at least partially therein.

15. The cutter of claim 14 wherein the at least on roller is retained to the base by pillow block

16. The cutter of claim 1 wherein the cutting deck is rotatable about the pivot in a range of −15 degrees to 90 degrees.

17. The cutter of claim 1 wherein the cutting deck is prevented from further rotation beyond −15 degrees by contact of the cutting deck with the first arm assembly.

18. The cutter of claim 1 further comprising a counterweight connected to the mounting plate oppositely disposed relative to the first arm assembly

19. The cutter of claim 1 wherein the second arm assembly has first and second portions connected together with a pin at one of a plurality of openings in the second portion.

20. The cutter of claim 1 wherein second arm assembly is pivotably connected at ends of the second arm assembly to the cutting deck and the first arm assembly, respectively.
